(19) United States
(12) Patent Application Publication
(10) Pub. No.: US 2014/0041279 A1
(43) Pub. Date: Feb. 13, 2014

(54) Fish Hook With Harpoon Member

(71) Applicant: Bryan Dalton, Redondo Beach, CA (US)

(72) Inventor: Bryan Dalton, Redondo Beach, CA (US)

(21) Appl. No.: 13/569,100

(22) Filed: Aug. 7, 2012

(51) Int. Cl. A01K 83/06; A01K 99/00

(52) U.S. Cl. 43/4.5; 43/44.82

(57) ABSTRACT

A fish hook including a hook member for engaging a fish and a harpoon member for engaging a bait, the hook member including a shank, a bend and a point, and the harpoon member including a shank and a barb. The hook shank and harpoon shank may be affixed together or formed from a common wire, and include a common eye for attaching a fishing line. The harpoon shank may parallel the hook shank, may be off-set or bent, and may include multiple barbs. The harpoon member is inserted into a bait in a first direction, thereby retaining the bait on the harpoon member while the fish hook is aimed in a second direction.

### BACKGROUND

Fish hooks are known in the art, as are fish hooks having associated anchoring members for preserving bait alongside the hook. Some examples of these designs include Strantz (U.S. Pat. No. 4,349,979) which discloses an elongated flexible plastic member added to the hook, Griffiths (U.S. Pat. No. 4,625,451) disclosing a ring-shaped holder for grasshoppers, crickets and the like, and Davis (U.S. Pat. No. 5,386,661) which includes a flexible secondary shaft which clasps the primary shaft. One problem with these designs is that the anchoring members are difficult to use in many applications and have a significant drawback when the hook twists and embeds itself into the bait, preventing a positive hook set into the target fish.

A fish hook with a solid bait holder is disclosed by Maitland (U.S. Pat. No. 6,038,806). Although this device does not allow the bait to move relative to the fish hook, the bait holder is a curved member traveling in substantially the same direction as the hook. Because the member travels the same direction of the hook and is firmly embedded, it is subject to the same drawback resulting in loss of hook ups to the target species. There is little advantage over traditional hooking of the bait by impaling it on the single hook shaft.

There is therefore a need for a fish hook that includes a harpoon member adapted to hold a bait adjacent the fish hook in a quick, easy and versatile application that allows the bait to be presented naturally to the target fish with the ability to camouflage the hook within the outlines of the bait. There is also a need for a fish hook that allows the hook to release from the bait once the target fish has swallowed it and subsequently hook the target species without interference from the bait. These and other embodiments will be further explained in the accompanying summary, description and claims.

### SUMMARY

An improved fish hook includes a hook member having a shank, bend and point, and harpoon member having a shank and barb. The hook shank and harpoon shank are affixed together, and a common eye is incorporated at an end of the hook member and harpoon member opposite the point and barb. The point and barb are disposed in substantially differing directions so that the hook may travel point-first through the water, while the barb pulls accompanying bait in tow. The point and barb may even be disposed in opposing directions.

A variety of barbs styles may accompany the harpoon shank. Among them, the barb may be a single heavy barb, a barb with tines, or a barb with a single tine. The harpoon shank may have multiple barbs as well. In addition to the barb configuration, the harpoon shank may be of several shapes. Among them, the shank may be substantially linear, off-set and angled, or bent. Also, the harpoon member may have multiple shanks where necessary for secure anchoring. In such a configuration, a secondary shank may be substantially perpendicular to the harpoon shank.

To minimize the cost of construction, the fish hook may be made from a single piece of wire bent to a desired shape, wherein the wire is bent to form the common eye. In this configuration the hook shank and harpoon shank may be separated and parallel, allowing bait to more securely affix to the harpoon member. If the hook member and harpoon member are constructed from multiple pieces instead of a single wire, they may be soldered, brazed or similarly attached together to form a common bond.

A weedless configuration of the fish hook is contemplated to obscure the point of the hook shank. In order to accomplish this configuration, the harpoon shank is angled such that the hook member doubles back into the bait, obscuring the point from view.

In order to use the fish hook, a fishing line is affixed to the eye and the harpoon member's shank and barb embedded in a bait in a first direction, anchoring the bait to the fish hook. The fish hook is then cast and reeled in a second direction substantially different, or opposite, direction.

### BRIEF DESCRIPTION OF THE FIGURES

FIG. 1 is a side view of a fish hook having a hook member affixed to a harpoon member.

FIGS. 2A-D are enlarged views of a harpoon shank having a single heavy barb, a barb with tines, a barb with a single tine, and a shank with multiple barbs.

FIGS. 3A-D are enlarged views of a conventional harpoon shank, a harpoon shank having an off-set angle, a bend, and a harpoon shank having two barbs.

FIG. 4 is a side view of a fish hook having a hook member and harpoon member formed of a single length of wire.

FIG. 5 is a side view of a fish hook having a hook member and harpoon member formed of a single length of wire affixed in bait.

FIG. 6 is a side view of a fish hook having a hook member and harpoon member adapted for a weedless configuration.

FIG. 7 is a side view of a fish hook having a hook member and harpoon member installed in bait in a weedless configuration.

FIG. 8 is a side view of a fish hook having a harpoon member installed in a bait, and a hook member outside the bait with the head end of the bait trailing.

FIG. 9 is a side view of a fish hook having a harpoon member installed in a bait, and a hook member outside the bait with the tail end of the bait trailing.

### DESCRIPTION

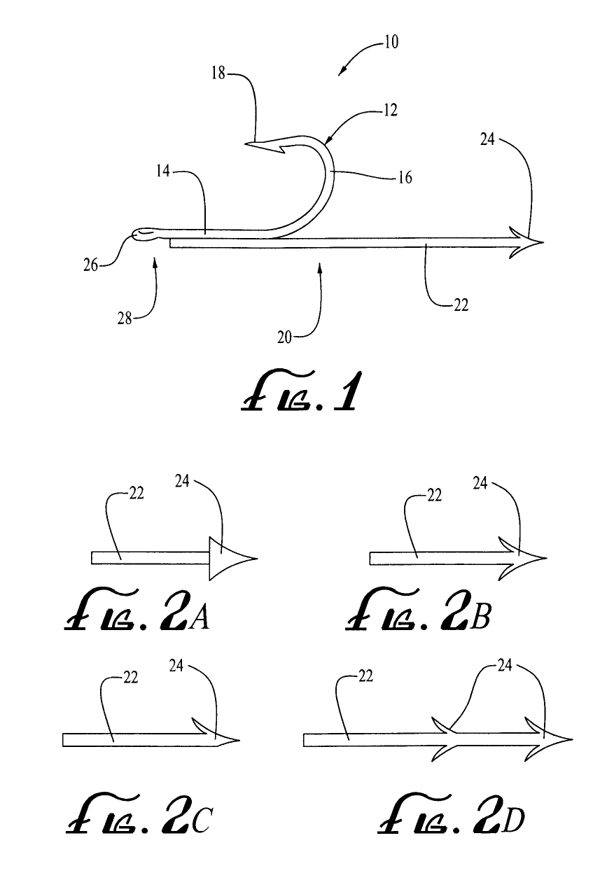

Referring to FIG. 1, a fish hook 10 includes a hook member 12 and a harpoon member 20. The hook member 12 includes a hook shank 14, a bend 16 and a point 18. The harpoon member 20 includes a harpoon shank 22 and a barb 24. The hook shank 14 and harpoon shank 20 are affixed together to preserve the position of the hook member 12 relative the harpoon member 20. A common eye 26 is incorporated into the fish hook 10 at an end 28 of the hook member 12 and harpoon member 20 opposite the point 18 and barb 24. The point 18 and barb 24 are disposed in substantially differing directions so that the hook may travel point 18 first through the water, while the barb 24 pulls an accompanying bait (not shown) in tow. In one embodiment, the point 18 and barb 24 are disposed in opposite directions.

A variety of barbs 24 may be incorporated into the harpoon shank 22. Among the contemplated embodiments illustrated in FIG. 2, the barb 24 may be a single heavy barb 24 as shown in FIG. 2A, a barb 24 with tines 30 as shown in FIG. 2B, and a barb 24 with a single tine 30 as shown in FIG. 2C. It is also contemplated that the harpoon shank 22 may have multiple barbs 24 as shown in FIG. 2D. The design and quantity of barbs 24 on the harpoon shank 22 will depend on bait characteristics.

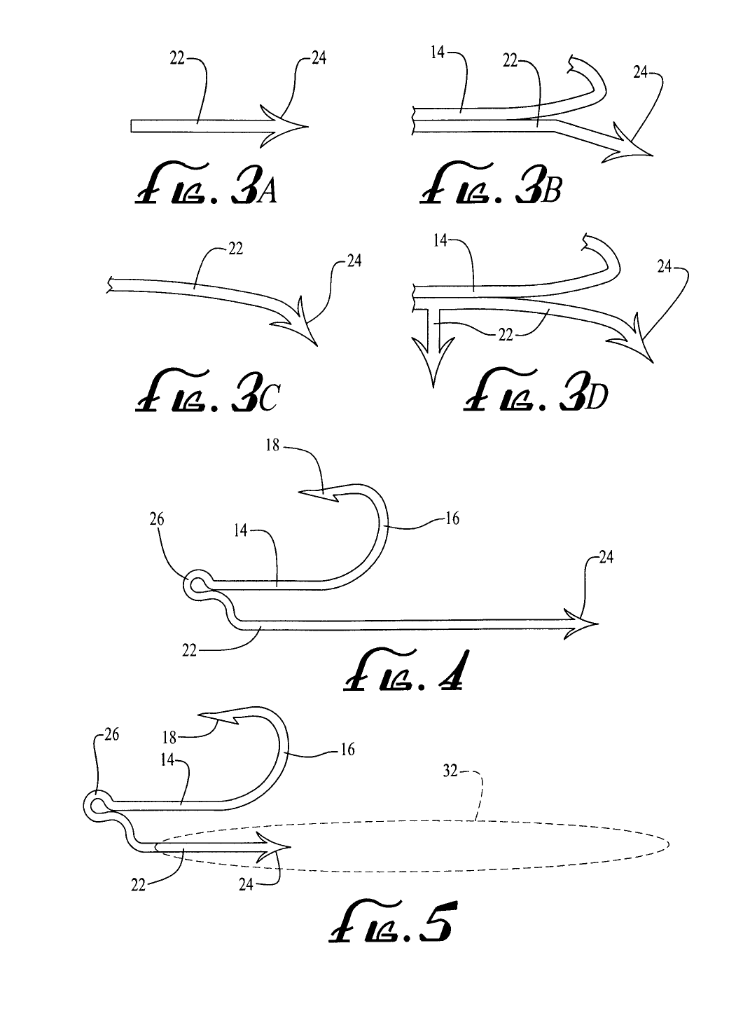

In addition to the barb 24 configuration, the harpoon shank 22 may have several embodiments as shown in FIG. 3. Among the contemplated embodiments are a substantially linear harpoon shank 22 as shown in FIG. 3A, an off-set angled harpoon shank 22 as shown in FIG. 3B, and a bent harpoon shank 22 as shown in FIG. 3C. Additionally, a harpoon member 20 having multiple harpoon shanks 22 and barbs 24 is also contemplated where necessary for secure anchoring in bait. In such a configuration, a secondary harpoon shank 32 may be substantially perpendicular to the harpoon shank 22.

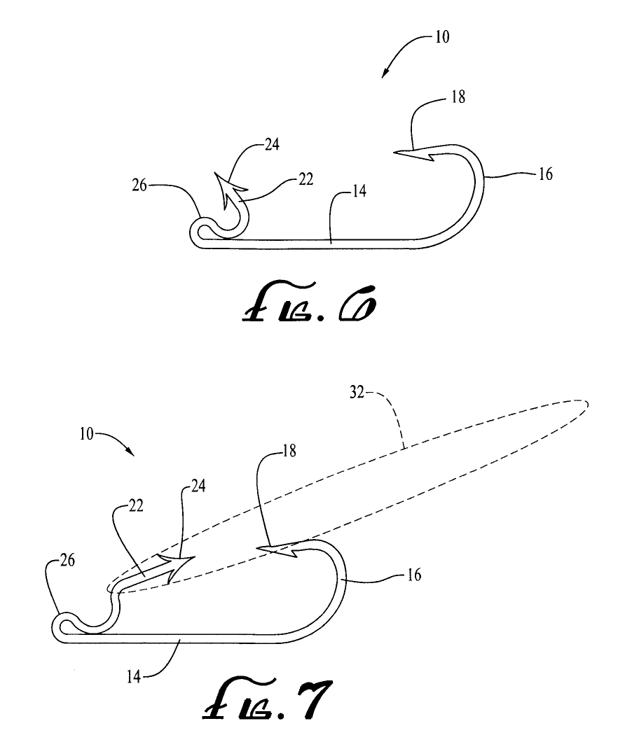

Referring to FIG. 4, to minimize the cost of construction, the fish hook 10 may be formed of a single piece of wire, bent to a desired shape. In this configuration, the wire is bent to form the common eye 26. Also in this configuration, the hook shank 14 and harpoon shank 22 may be separated, off-set and parallel, allowing a bait (not shown) to more securely affix to the harpoon shank 22. Referring to FIG. 5, a bait 34 is shown installed on the harpoon shank 22, extending almost to the common eye 26. In embodiments where the hook member 12 and harpoon member 20 are constructed from two pieces, they may be soldered or brazed together to form a common bond.

Referring to FIG. 6, another single wire configuration is illustrated wherein the hook member 12 and point 18 may trail behind the harpoon member 20, allowing the bait (not shown) to travel in advance of the hook member 12.

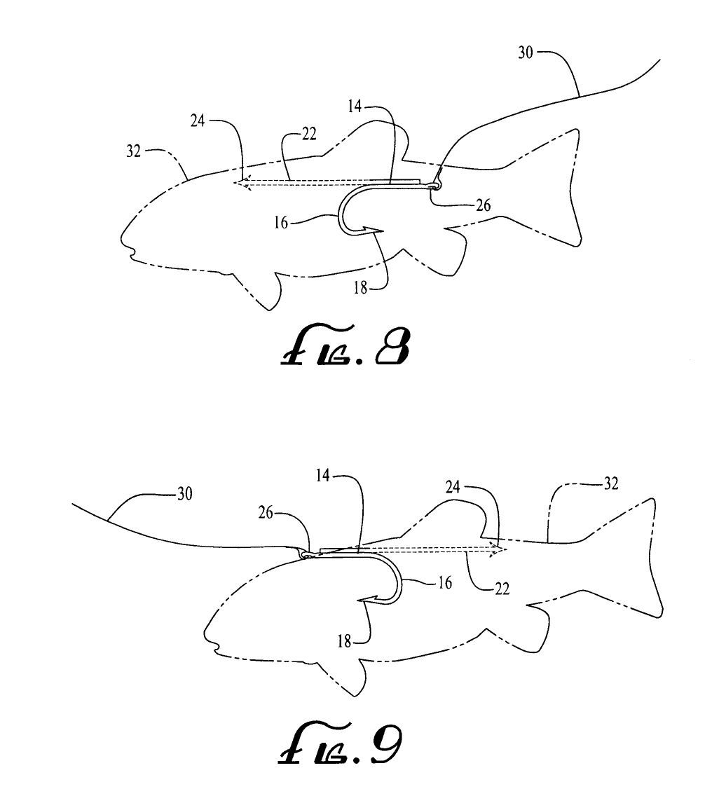

Referring to FIG. 7 a weedless configuration of the fish hook 10 is also contemplated. In order to obscure the point 18 of the hook shank 14, the harpoon shank 22 is angled such that the hook member 12 doubles back into the bait 34, obscuring the point 18 from view.

Referring to FIGS. 8 and 9, the fish hook 12 is shown installed in a bait 32.

In FIG. 8, the fish hook 12 is installed such that the bait 32 travels tail first when reeled in. The harpoon shank 22 and barb 24 is embedded in the bait 32, while the hook bend 16 and point 18 remain external to the bait. In FIG. 9, the fish hook is installed such that the bait 32 travels head-first when reeled in. The harpoon shank 22 and hook bend 16 and point 18 are in substantially the same configuration.

The structures of the fish hook 10 having been shown and described, a preferred method of use will now be discussed.

In order to use the fish hook 10, as shown in FIGS. 8 and 9, a fishing line 30 is affixed to the fish hook 10 at the common eye 26, thereby securing both the hook shank 14 and harpoon shank 22. With the fishing line 30 secure, the harpoon member 20 is then embedded in the bait 32 in a first direction, such that the harpoon shank 22 and barb 24 anchor the bait 32 to the fish hook 10. The fish hook 10 is then cast and reeled in a second direction substantially different from the first direction, including opposite to the first direction. In an alternative embodiment, the fish hook 10 may be affixed to the bait first, and then the fishing line 30 attached to the common eye 26.

The fish hook 10 and bait 32 may then be cast and reeled in such that the point 18 travels in the reeled direction accompanied by the bait 32 anchored to the harpoon member 22. It is also contemplated that the point 18 may be embedded in the bait 32 to form a weedless configuration. In this manner, the bait 32 may be removed from the fish hook 10 without damage to the bait 32, and another piece of bait installed on the fish hook 10 as desired.

The foregoing description of the preferred embodiment of the invention is sufficient in detail to enable one skilled in the art to make and use the invention. It is understood, however, that the detail of the preferred embodiment presented is not intended to limit the scope of the invention, in as much as equivalents thereof and other modifications which come within the scope of the invention as defined by the claims will become apparent to those skilled in the art upon reading this specification.

What is claimed is:

1. A fish hook 10 comprising:
a hook member 12 having a hook shank 14, a bend 16, and a point 18;
a harpoon member 20 having a harpoon shank 22 and a barb 24;
wherein the hook member 12 and harpoon member 20 share a common eye 26;
and wherein the hook member 12 and harpoon member 20 are disposed such that the point 18 and barb 24 aim in substantially differing directions.

2. The fish hook of claim 1 wherein the point and barb aim in substantially opposite directions.

3. The fish hook of claim 1 wherein the harpoon shank comprises a single heavy barb.

4. The fish hook of claim 1 wherein the barb comprises a single sided tine.

5. The fish hook of claim 1 wherein the barb comprises a single set of tines.

6. The fish hook of claim 1 wherein the harpoon shank comprises multiple barbs.

7. The fish hook of claim 1 wherein the harpoon shank is substantially linear.

8. The fish hook of claim 1 wherein the harpoon shank is disposed at an offset angle.

9. The fish hook of claim 1 wherein the harpoon shank comprises a bend.

10. The fish hook of claim 1 wherein the harpoon shank comprises a secondary harpoon shank member and secondary barb.

11. The fish hook of claim 10 wherein the secondary harpoon shank member is substantially perpendicular to the harpoon shank.

12. The fish hook of claim 1 wherein the hook member and harpoon member are affixed together by soldering.

13. The fish hook of claim 1 wherein the hook member and harpoon member are affixed together by brazing.

14. The fish hook of claim 1 wherein the hook member and harpoon member are formed from a single length of wire.

15. The fish hook of claim 14 wherein the wire forms the eye of the fish hook.

16. The fish hook of claim 14 wherein the hook shank and harpoon shank are offset and parallel.

17. A method of fishing comprising the steps of:
providing a fish hook having a hook member adjacent a harpoon member having a shank and a barb;
affixing a fishing line to the fish hook;
urging the shank and barb in a first direction into a bait while retaining the hook member external to the bait;
casting the fishing line bearing the bait and the fish hook; and, reeling the fishing line in a second direction substantially opposite from the first direction;
thereby retaining the bait on the harpoon member adjacent the hook member.

18. The method of claim 17 including the step of affixing a point of the hook member into the bait thereby forming a weedless lure.

19. The method of claim 17 further comprising the step of removing the harpoon member from the bait without damaging the bait, and inserting the harpoon member into another piece of bait.
